(19) United States
(12) Patent Application Publication
(10) Pub. No.: US 2005/0138415 A1
(43) Pub. Date: Jun. 23, 2005

(54) Locking a device into a specific mode

(76) Inventors: Ryan S. Russell, Hillsboro, OR (US); Scott D. Boss, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/739,383

(22) Filed: Dec. 17, 2003

(51) Int. Cl. H04L 9/00

(52) U.S. Cl. 713/201

(57) ABSTRACT

In some embodiments, a state of a lock of a system is sensed, and the system is switched between a normal mode and a special mode in response to the sensing. Other embodiments are described and claimed.

### TECHNICAL FIELD

The inventions generally relate to locking a device into a specific mode.

### BACKGROUND

Many parents view computing devices such as desktop computers as a distraction for their children. Unless the parent sits by the child and watches them use the computer, they have no way of knowing if the child is using the computer for educational activities, or merely playing games or surfing the internet.

One product that was made available in China is called a “Xuexiji” or “learning machine”. These learning machines were not very successful because the child would simply remove the educational cartridge that the parent wanted the child to use and replace it with a game cartridge when the parent wasn't looking. These learning machines were not provided with a way to ensure that the child was using the product for the educational purposes intended by the parents of the child.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation according to some embodiments of the inventions.

### DETAILED DESCRIPTION

Some embodiments of the inventions relate to locking a device into a specific mode. Such a device could be a system, a computing device, a computer, or some other type of device or system. Some embodiments of the inventions relate to locking a computing device into a specific mode. Some embodiments of the inventions relate to locking a system into a specific mode. Some embodiments of the inventions relate to locking a computer into a specific mode.

In some embodiments, a state of a lock of a device is sensed, and the device is switched between a normal mode and a special mode in response to the sensing.

In some embodiments, a device and/or system includes a locking mechanism and a switching mechanism. The switching mechanism is to switch the device and/or system between a normal mode and a special mode in response to the locking mechanism.

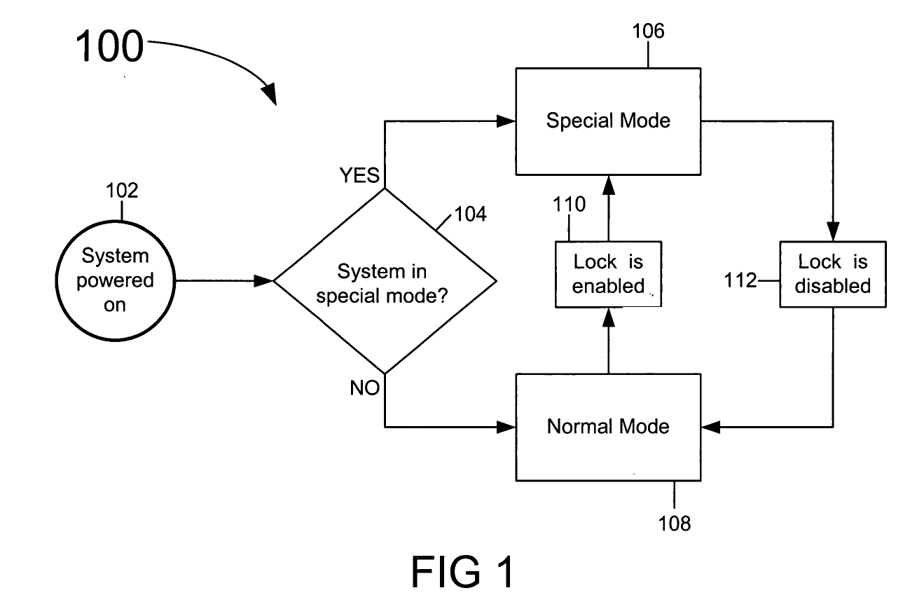

FIG. 1 illustrates a flow diagram 100 according to some embodiments. Flow diagram 100 includes a state 102 in which the system (for example, a computing device) is powered on, a decision 104 as to whether the system is in a special mode, a special mode 106 (for example, a contained/protected environment/mode), a normal mode 108 (for example, a normal operating system mode of a computing device), a lock enabling 110 and a lock disabling 112. When the system is powered on at 102, then decision 104 determines whether the system has already previously been set to the special mode. If so, then the system is put into the special mode 106. If not, then the system is put into the normal mode 108. Once the system is in special mode 106 it stays in that mode. The system only transfers from the special mode 106 to the normal mode 108 if a lock is disabled at 112. Similarly, once the system is in the normal mode 108 it stays in that mode. The system transfers from the normal mode 108 to the special mode 106 if the lock is enabled at 110.

In some embodiments the system (a computing device) may be locked into the special mode so that only certain software is available to the user. In some embodiments the software available to the user in the special mode is software that is chosen by a user or owner of the system. Once in the special mode a user cannot get out of the special mode unless they are able to disable the lock to unlock the system and switch it over to the normal mode. In some embodiments even if a user tries to turn off the system it remains in the special mode. When the user turns the system on again the system remains in the special mode, via 102, 104 and 106 of FIG. 1, for example. In some embodiments the decision at 104 is made because the system remembers that it is in the special mode upon power up. In some embodiments the decision at 104 is made in response to checking the status of the lock mechanism (for example, if the lock is enabled then the system is in the special mode and moved to 106, if the lock is disabled then the system is not in the special mode and moved to 108).

In some embodiments the system of FIG. 1 may be a computing device (for example, a desktop computer such as a PC (personal computer), a laptop computer, a set top box, a computer tablet, a handheld device, etc.) In some embodiments the lock of FIG. 1 may be a hardware locking mechanism such as a physical lock and key, a thumbprint reader, a smart card reader, a USB key, or any other type of hardware locking mechanism. In some embodiments the lock may be a hardware locking mechanism located on a chassis of the computer or integrated into a monitor stand, for example. In some embodiments a physical lock and key may be used where the system (for example, a computing device such as a desktop PC) is unlocked when the key has turned the lock to one position (for example, vertical) and is locked when the key has turned the lock to another position (for example, horizontal).

In some embodiments the special mode is a contained/protected environment mode. In some embodiments the special mode is a special learning mode. In some embodiments the special mode is a special learning mode set up by a parent to lock the system (computing device) so that a child only has access to educational applications. In some embodiments the educational applications to which the child has access can include, for example, applications to help the child learn and/or practice a language such as English, learn and/or practice mathematics, learn and/or practice language characters such as Chinese, and/or any other educational applications.

In some embodiments the system is a computing device and when the computing device is unlocked it is in the normal mode, which is a normal Operating System (OS) of the computing device (for example, in which the computing device system functions as a normal computing device such as a PC and the normal OS desktop is visible to the user). In some embodiments the normal mode is a Microsoft Windows XP OS. In some embodiments a physical lock and key is used to implement the lock.

In some embodiments (for example, those illustrated in FIG. 1) only one special mode is implemented. In some embodiments two or more special modes may be implemented. For example, a first special mode may exist as a special learning mode for one child and a second special mode may exist as a special learning mode for a second child, where a different choice of learning applications is available to each child depending on their age, grade level, capabilities, etc. In some embodiments the lock may be moved to a different position to choose between the two or more different special modes. In some embodiments other ways may be used to choose between the two or more different special modes (for example, user input while the system is in the normal mode).

In some embodiments the system may sometimes be used as a learning device when the system is locked into a special learning mode (for example, by parents wanting their children to only use the system for educational purposes). When the system is locked into the special learning mode (or child mode) the parents can relax in the knowledge that the only content or software that their child can access is learning and/or educational based, for example. In such embodiments the only way for a child to get to other features or functions of the system (for example, such as games or the internet) is for parents to unlock the system. This is particularly useful where the system is a personal computer with easy access to games, internet and other distractions for a child not to perform the educational and learning activities that a parent wishes upon a child.

In some embodiments when a system is in the normal mode the portion of the system that is visible to a user (for example, on a display screen) appears normally. For example, in the case of a computing device the normal operation of the computing device occurs with normal operating system desktop software, applications, etc. appearing on the screen. In some embodiments when the system is in the special mode only certain activities may be accessed (for example, educational and learning activities chosen by a parent), and only those accessible activities, applications, etc. are visible to the user (for example, a child) when the system is in the special mode.

In some embodiments when the system is in the special mode only certain activities may be accessed by the system. For example, if a USB device is plugged into the system, a game cartridge is plugged into the system, a printer is removed from the system, a new application is inserted in the CD-ROM drive, floppy drive, DVD-ROM drive, etc., it is ignored until the system is unlocked and returns to the normal mode. In some embodiments even if the system is turned off when it is in the special mode it automatically returns to the special mode when it is turned back on.

In some embodiments the lock is implemented as a hardware locking mechanism. In some embodiments the switching and/or managing of the normal mode and the one or more special modes is implemented in software.

Although some computing device operating systems such as Microsoft Windows have features that support multiple users on a single computer, there are no previous systems such as personal computers or other computing devices that allow the system to be locked into one or more special modes. In some embodiments of the inventions the system can be locked into a special mode where all of the software and/or content that can be accessed in that mode are beneficial to a child's studies.

Although most of the embodiments described above have been described in reference to particular implementations such as implementing a learning device for children when the system is in a special mode, other implementations are possible according to some embodiments. For example, the implementations described herein may be used to implement any embodiments that may be used to lock a system such as a computing device in a special mode that is different from a normal mode of the system according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. A method comprising:
sensing a state of a lock of a device; and
switching the device between a normal mode and a special mode in response to the sensing.

2. The method according to claim 1, wherein the state of the lock is at least one of an enabling of the lock and a disabling of the lock.

3. The method according to claim 1, further comprising:
sensing an enabling of the lock; and
switching the device from the normal mode to the special mode in response to the enabling.

4. The method according to claim 1, further comprising:
sensing a disabling of the lock; and
switching the device from the special mode to the normal mode in response to the disabling.

5. The method according to claim 1, further comprising:
sensing a power on of the device;
determining whether the device is set to be in the normal mode or the special mode; and
switching the device into one of the special mode and the normal mode in response to the determining.

6. The method according to claim 5, wherein the determining is performed in response to the state of the lock.

7. The method according to claim 1, wherein the lock is a hardware locking mechanism.

8. The method according to claim 1, wherein the device is a computing device.

9. The method according to claim 8, wherein the computing device is at least one of a desktop computer, a personal computer, a laptop computer, a handheld device, a set top box, and a tablet.

10. The method according to claim 1, wherein the special mode is a special contained and protected environment mode.

11. The method according to claim 1, wherein the special mode is a special educational mode.

12. The method according to claim 1, wherein the device is a computing device and the normal mode is a normal operating system mode.

13. The method according to claim 1, further comprising switching the device between the normal mode and at least one additional special mode in response to the sensing.

14. The method according to claim 1, further comprising switching the device between at least one additional special mode and at least one of the normal mode and the special mode.

15. The method according to claim 14, wherein the switching between at least one additional special mode and at least one of the normal mode and the special mode is implemented in response to a user input.

16. The method according to claim 1, further comprising switching the device between the normal mode, the special mode and at least one additional special mode.

17. The method according to claim 16, wherein the switching of the device between the normal mode, the special mode and the at least one additional special mode is performed in response to the sensing.

18. An article comprising:
a computer readable medium having instructions thereon which when executed cause a computer to:
sense a state of a lock of a device; and
switch the device between a normal mode and a special mode in response to the enabling.

19. The article according to claim 18, the computer readable medium further having instructions thereon which when executed cause a computer to:
sense an enabling of the lock; and
switch the device from the normal mode to the special mode in response to the enabling.

20. The article according to claim 18, the computer readable medium further having instructions thereon which when executed cause a computer to:
sense a disabling of the lock; and
switch the device from the special mode to the normal mode in response to the disabling.

21. The article according to claim 18, the computer readable medium further having instructions thereon which when executed cause a computer to:
sense a power on of the device;
determine whether the device is set to be in the normal mode or the special mode; and
switch the device into one of the special mode and the normal mode in response to the determining.

22. The article according to claim 21, the computer readable medium further having instructions thereon which when executed cause a computer to perform the determining in response to the state of the lock.

23. A system comprising:
a locking mechanism; and
a switching mechanism to switch the system between a normal mode and a special mode in response to the locking mechanism.

24. The system according to claim 23, wherein the switching mechanism is to switch the system between the normal mode and the special mode in response to at least one of an enabling of the lock and a disabling of the locking mechanism.

25. The system according to claim 23, wherein the switching mechanism is to switch the system from the normal mode to the special mode in response to an enabling of the locking mechanism.

26. The system according to claim 23, wherein the switching mechanism is to switch the system from the special mode to the normal mode in response to a disabling of the locking mechanism.

27. The system according to claim 23, the switching mechanism to sense a power on of the system, to determine whether the system is set to be in the normal mode or the special mode, and to switch the system into one of the special mode and the normal mode.

28. The system according to claim 27, the switching mechanism to sense a power on of the system, and to switch the system into one of the special mode and the normal mode in response to the locking mechanism.

29. The system according to claim 23, wherein the locking mechanism is a hardware locking mechanism.

30. The system according to claim 29, wherein the hardware locking mechanism is at least one of a physical lock and key, a thumbprint reader, a smart card reader, and a USB key.

31. The system according to claim 23, wherein the locking mechanism is located on a chassis of the system.

32. The system according to claim 23, wherein the locking mechanism is located on a monitor stand.

33. The system according to claim 23, wherein the system is a computing device.

34. The system according to claim 33, wherein the computing device is at least one of a desktop computer, a personal computer, a laptop computer, a handheld device, a set top box, and a tablet.

35. The system according to claim 23, wherein the special mode is a special contained and protected environment mode.

36. The system according to claim 23, wherein the special mode is a special educational mode.

37. The system according to claim 23, wherein the system is a computing device and the normal mode is a normal operating system mode.

38. The system according to claim 23, the switching mechanism further to switch the system between the normal mode and at least one additional special mode in response to the locking mechanism.

39. The system according to claim 23, the switching mechanism further to switch the device between at least one additional special mode and at least one of the normal mode and the special mode.

40. The system according to claim 23, the switching mechanism further to switch the device between at least one additional special mode and at least one of the normal mode and the special mode in response to a user input.

41. The system according to claim 23, the switching mechanism to switch the device between the normal mode, the special mode and at least one additional special mode.

42. The system according to claim 41, the switching mechanism to switch the device between the normal mode, the special mode and at least one additional special mode in response to the locking mechanism.
